(19) United States
(12) Patent Application Publication
(10) Pub. No.: US 2025/0217347 A1
(43) Pub. Date: Jul. 3, 2025

(54) SCANNING LAYER FOR UNPROTECED USER-DEFINED FUNCTIONS

(71) Applicant: Teradata US, Inc., San Diego, CA (US)

(72) Inventor: Ashish Chaube, Roopnagar (IN)

(21) Appl. No.: 18/401,592

(22) Filed: Dec. 31, 2023

(51) Int. Cl. G06F 16/23

(52) U.S. Cl. CPC G06F 16/2365

(57) ABSTRACT

A system includes a plurality of processing nodes. at least one processing node of the plurality of processing nodes receives a user-defined function. The at least one processing node scans source code of the user-defined function. The at least one processing node, in response to identification of at least one of a plurality of predetermined conditions in the user-defined function during the scan, requires that the UDF is executed at a secure server outside of the plurality of processing nodes.

### BACKGROUND

User-defined functions (“UDFs”) are powerful functions that allow specific functionality to be applied within an analytic environment, such as a relational database management system (“RDBMS”). UDFs provide a mechanism by which default analytic and processing capabilities of a database or other analytic environment may be extended to provide an advanced or customer-specific set of capabilities. Such UDFs allow relevant query-language to execute the function to carry out the intended result.

UDFs may be created by the same parties that create the RDBMS ensuring those internal UDFs may be trusted for execution within the RDBMS. However, externally-created UDFs, such as those created by users and/or customers cannot be initially trusted for execution by the UDFs. This requires an inefficient process to install and execute an externally-created UDF.

Because installation of an externally-created UDFs requires an inefficient use of resources, it is desirable to enhance inspection of an externally-created UDFs.

### SUMMARY

According to one aspect of the disclosure, a system may include a plurality of processing nodes. At least one processing node of the plurality of processing nodes may receive a user-defined function. The at least one processing node may scan source code of the user-defined function. The at least one processing node may, in response to identification of at least one of a plurality of predetermined conditions in the user-defined function during the scan, require that the UDF is executed at a secure server outside of the plurality of processing nodes.

According to another aspect of the disclosure, a method may include receiving, with a processor, a user-defined function. The method may include scanning, with the processor, source code of the user-defined function. The method may include, in response to identification of at least one of a plurality of predetermined conditions in the user-defined function during the scan, requiring, with the processor, that the UDF is executed at a secure server outside of the plurality of processing nodes.

According to another aspect of the disclosure, computer-readable medium may be encoded with a plurality of instructions executable by a processor. The plurality of instructions may include instructions to receive a user-defined function. The plurality of instructions may include instructions to scan source code of the user-defined function. The plurality of instructions may include, in response to identification of at least one of a plurality of predetermined conditions in the user-defined function during the scan, instructions to require that the UDF is executed at a secure server outside of the plurality of processing nodes.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

| FIG. 4 is a detailed block diagram of a parser module.

FIG. 5 is a block diagram of an example operation of a relational database management system upon receipt of an externally-created UDF.

FIG. 6 is a block diagram of a relational database management system upon receipt of an externally-created UDF using a scanning layer.

FIG. 7 is an operational flow diagram of a relational database management system upon receipt of an externally-created UDF using a scanning layer.

### DETAILED DESCRIPTION OF THE FIGURES

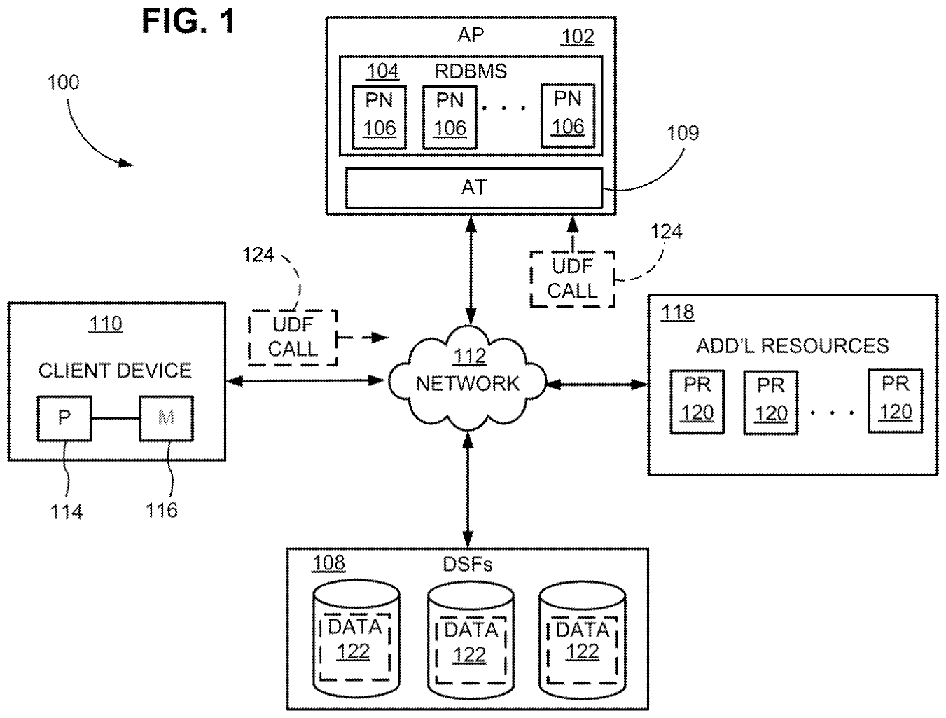

FIG. 1 is block diagram of an example analytic environment 100. In one example, the analytic environment 100 may include an analytic platform (“AP”) 102, such as Teradata Vantage. The analytic platform 102 may include one or more systems that may be used independently or with one another in carrying out advanced analytics. The analytic platform 102 may include a relational database management system (“RDBMS”) 104. In one example, the RDBMS 104 may implement a parallel-processing environment to carry out database management. The RDBMS 104 may be a combination of software (e.g., computer program routines, subroutines, applications, etc.) and hardware (e.g., processors, memory, etc.). In the example of FIG. 1, the RDBMS 104 may be a massive parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory (ies) 116. The network 112 may be wired, wireless, or some combination thereof. The network 112 may be a cloud-based environment, virtual private network, web-based, directly-connected, or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

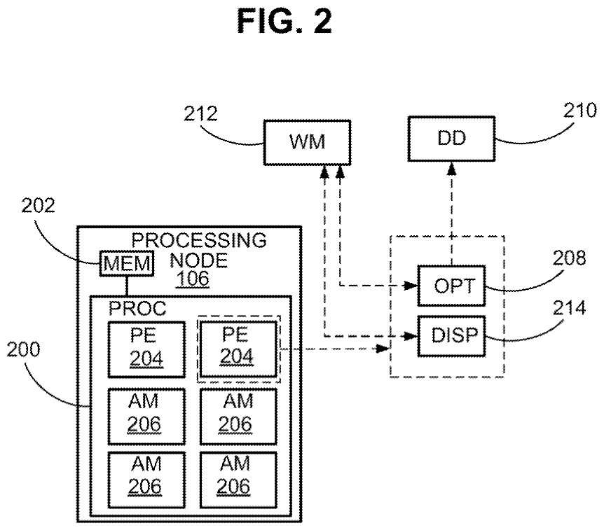

FIG. 2 is an example of a processing node 106, which may include one or more physical processors 200 and memory (ies) 202. The memory 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which comprises instructions executable with the processor 200 or other processor to implement one or more of the features of the module. When any one of the modules includes the portion of the memory that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Active Data Warehousing System®.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIG. 1, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 102 stores data 122 in one or more tables in the DSFs 108. In one example, the data 122 may represent rows of stored tables are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

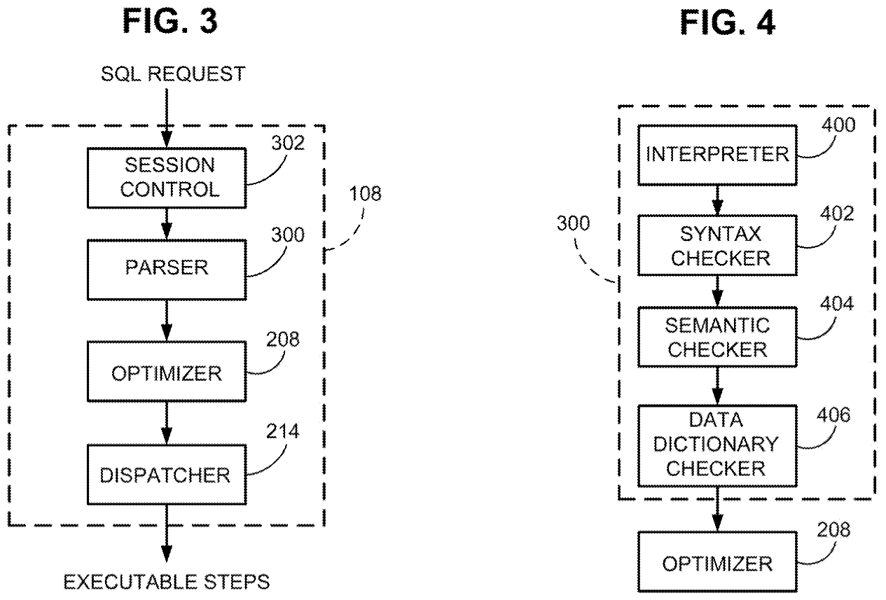

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 108 for purposes of illustration.

The data dictionary module 210 may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g., adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, an SQL request may be received such as through submission by a user and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

Referring back to FIG. 1, during operation user-defined functions (“UDFs”) may be used to perform various tasks on data 122. A UDF call may be made via the client device 110, which may cause the RDBMS 104 to execute the associated UDF on data described in a query with the UDF call. However, UDFs must first be installed in the RDBMS 104. User-defined functions may be internal to the RDBMS 104, such as by those with internal RDBMS privileges. However, entities, such as customers, may create their own UDFs external to the RDBMS 104 to be executed by the RDBMS 104.

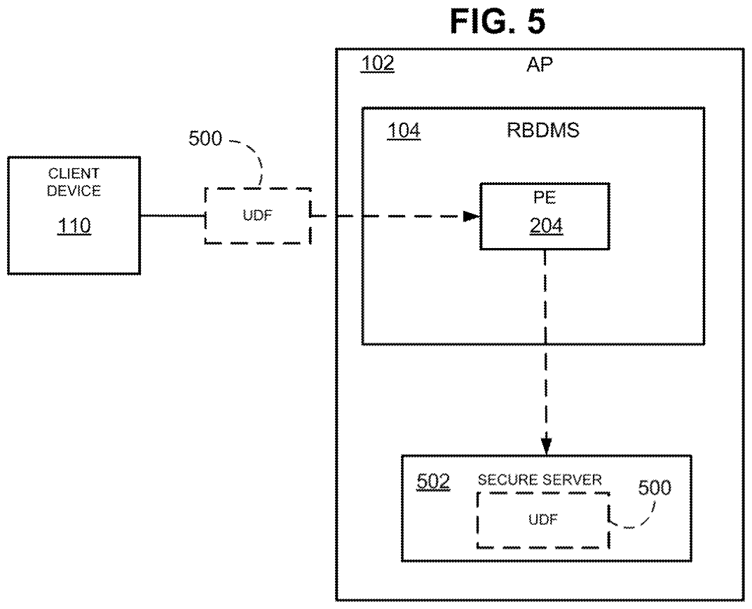

Currently, upon receipt of externally-created UDFs, the RDBMS 104 operates in a “protected” mode to execute the UDF. FIG. 5 is an example of how the protected mode is implemented. In one example, an externally-created UDF 500 is received for installation by the RDBMS 104. Since the RDBMS 104 is unaware of user-created UDF contents, the RDBMS may operate in protected mode to avoid the potential of malicious or otherwise dangerous contents of the externally-created UDF 500. In one example, protected mode may involve a secure server 502 outside the RDBMS 104 being used to execute the externally-created UDF 500. While use of the secure server 502 protects the RDBMS 104 from potential harm due the externally created RDBMS 104, performance is negatively impacted. Execution of the externally-created UDF 500 requires additional resources that would not typically be required for UDFs executed in the RDBMS 104, such as shared memory and a separate container for execution.

To avoid this downgrade in performance, a scanning layer may be introduced that scans an externally-created UDF prior to installation allowing a decision to be made as to the potential harmfulness of a received UDF. Scanning an externally-created UDF prior to execution, may allow the externally-created UDF to be installed and executed in the RDBMS 104 that would otherwise require execution at the secure server 502.

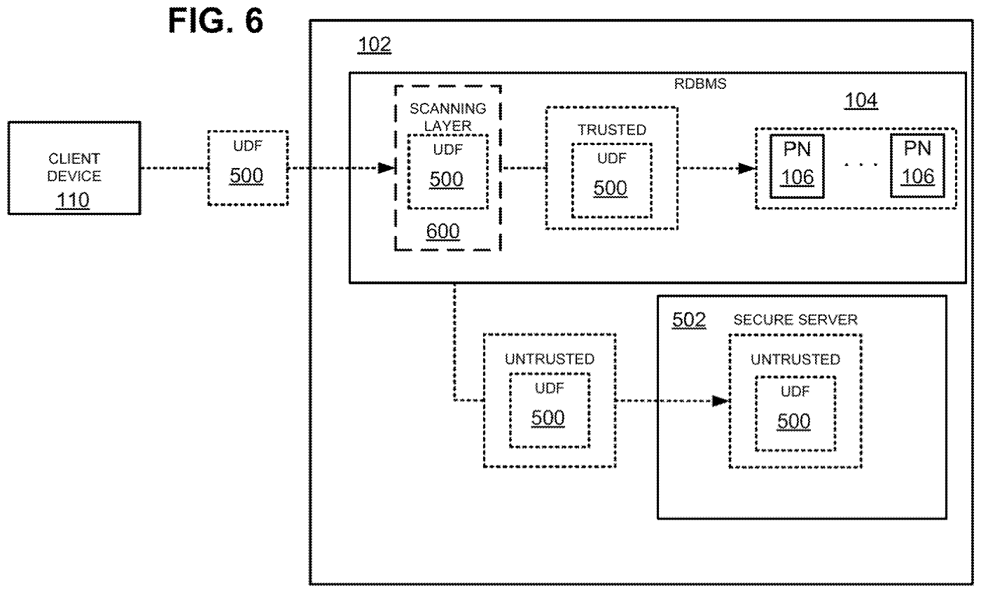

FIG. 6 is an example of use of a scanning layer 600. The scanning layer 600 may be executed by the RDBMS 104 (such as through processing nodes 106) during a UDF installation phase or may be executed outside the RDBMS 104 with additional software and/or hardware. In particular, externally-created UDFs may be installed in the RDBMS 104 libraries, such that UDF calls may be subsequently made to the UDF for execution on particular data identified in the UDF call. The scanning layer 600 may be executed using one or more processing nodes 106 of the RDBMS 104. The scanning layer 600 may determine an externally-created UDF 500 can be trusted by evaluating the source code. If the externally created UDF 500 can be trusted it, may be installed and executed within the RDBMS 104 via processing nodes 206. If the scanning layer 600 determines the externally-created UDF 600 cannot be trusted, the externally-created UDF 500 may be executed at the secure server 502. In one example, the scanning layer 600 may determine an externally-created UDF as untrusted if the scanning layer 600 identifies any capability required beyond the functionality of the UDF, such as any system call interacting with the operating system (“OS”) or file-handling commands, for example.

For untrusted externally-created UDFs, the scanning layer 600 may also categorize the types of issues the untrusted UDFs may include, such as: OS level calls; code for corrupting/deleting files and/or directories; checking for access to non-permissible directories; and accessing other system diagnostics, for example. The scanning layer 600 may also offer corrective actions if source code of the untrusted externally-created UDFs include potential threats and/or bad coding practice.

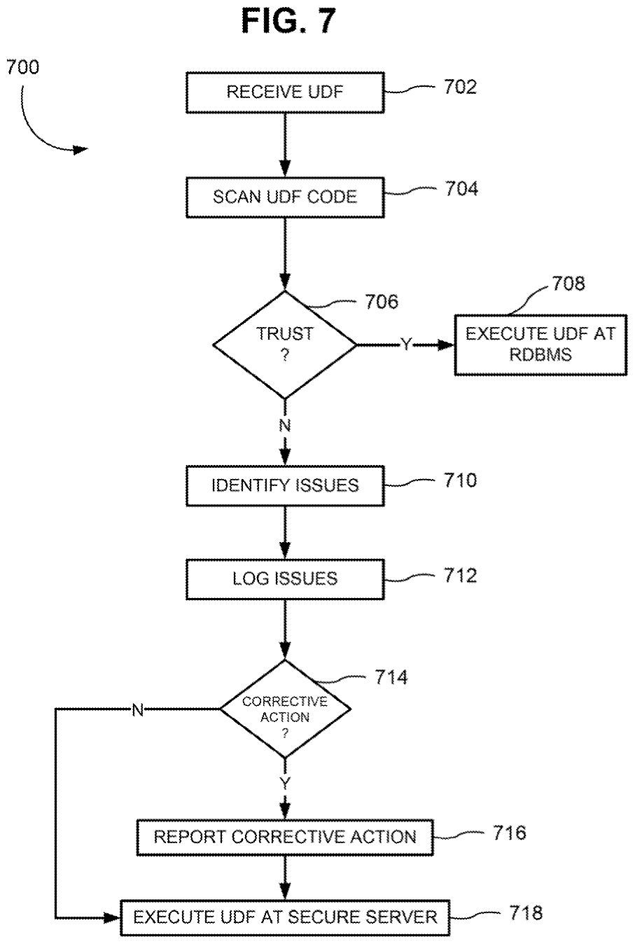

FIG. 7 is an operational flow diagram of example operation of the scanning layer 600 (700). In one example, the scanning layer 600 may receive an externally-created UDF (702), such as externally-created UDF 500, during a UDF installation. The scanning layer 600 may scan the source code of the externally-created UDF (704). Based on the scan, the scanning layer 600 may determine if the externally-created UDF can be trusted (706) in the manner previously described. If the externally-created UDF can be trusted, the externally-created UDF may be executed at the RDBMS 104 (708).

If the externally-created UDF cannot be trusted (706), the scanning layer 600 may identify the issues with the externally-created UDF causing it to not be trusted (710). These issues may be logged within the RDBMS 104 (712). The scanning layer 600 may then determine if corrective action may be taken (714). If so, the scanning layer 714 may report the corrective action to a source of the UDF or other recipient (716). If no, corrective action is to be reported or once the corrective action has been reported, the scanning layer 600 may require the untrusted externally-created UDF to be executed at the secure server 502.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

1. A system comprising:
a plurality of processing nodes, wherein at least one processing node of the plurality of processing nodes is configured to:
receive a user-defined function (“UDF”);
scan source code of the UDF; and
in response to identification of at least one of a plurality of predetermined conditions in the user-defined function during the scan, require that the UDF is executed at a secure server outside of the plurality of processing nodes, wherein the at least one of a plurality of conditions is associated with unauthorized content of the UDF.

2. The system of claim 1, wherein the at least one processing node is further configured to, in response to absence of the plurality of predetermined conditions, direct the UDF to be executed by one or more of the plurality of processing nodes.

3. The system of claim 1, wherein the plurality of predetermined conditions comprises operating system level calls, access check of non-permissible directories, and existence of source code that causes corruption or deletion of files or directories.

4. The system of claim 1, wherein the at least one processing node is configured to identify a corrective action for the UDF that is executed at the secure server outside of the plurality of processing nodes.

5. A method comprising:
receiving, with a processor, a user-defined function (“UDF”);
scanning, with the processor, source code of the user-defined function; and
in response to identification of at least one of a plurality of predetermined conditions in the user-defined function during the scan, requiring, with the processor, that the UDF is executed at a secure server outside of the plurality of processing nodes, wherein the at least one of a plurality of conditions is associated with unauthorized content of the UDF.

6. The method of claim 5, further comprising, in response to absence of the plurality of predetermined conditions, directing, with the processor, the UDF to be executed by one or more of the plurality of processing nodes.

7. The method of claim 5, wherein the plurality of predetermined conditions comprises operating system level calls, access check of non-permissible directories, and existence of source code that causes corruption or deletion of files or directories.

8. The method of claim 5, further comprising identifying, with the processor, a corrective action for the UDF that is executed at the secure server outside of the plurality of processing nodes.

9. A non-transitory computer-readable medium encoded with a plurality of instructions executable by a processor, the plurality of instructions comprising:
instructions to receive a user-defined function;
instructions to scan source code of the user-defined function (“UDF”); and
in response to identification of at least one of a plurality of predetermined conditions in the user-defined function during the scan, instructions to require that the UDF is executed at a secure server outside of the plurality of processing nodes, wherein the at least one of a plurality of conditions is associated with unauthorized content of the UDF.

10. The non-transitory computer-readable medium of claim 9, wherein the plurality of instructions further comprises, in response to absence of the plurality of predetermined conditions, instructions to direct the UDF to be executed by one or more of the plurality of processing nodes.

11. The non-transitory computer-readable medium of claim 9, wherein the plurality of predetermined conditions comprises operating system level calls, access check of non-permissible directories, and existence of source code that causes corruption or deletion of files or directories.

12. The non-transitory computer-readable medium of claim 9, wherein the plurality of instructions further comprises instructions to identify a corrective action for the UDF that is executed at the secure server outside of the plurality of processing nodes.
